(19) United States
(12) Patent Application Publication
(10) Pub. No.: US 2011/0018297 A1
(43) Pub. Date: Jan. 27, 2011

(54) CONSOLE FOR AUTOMOBILE

(75) Inventors: Nakry Chheang, St Remy Les Chevreuse (FR); Laurent Laumesfeld, Ville d'Avray (FR); Thierry Marceau, Rueil Malmaison (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: RENAULT S.A.S., Boulogne-Billancourt (FR)

(21) Appl. No.: 12/933,815

(22) PCT Filed: Jan. 5, 2009
(86) PCT No.: PCT/FR2009/050005

§ 371 Date: Sep. 21, 2010

(30) Foreign Application Priority Data
Mar. 27, 2008 (FR) 0851962

(51) Int. Cl. B60R 7/04

(52) U.S. Cl. 296/24.34

(57) ABSTRACT

A bracket configured to be attached to the frame of an automobile that includes a shell defining a housing, and a reinforcement attached to the shell within the housing, for reinforcing the stiffness of the shell. The reinforcement includes at least one reinforcing member of the same material as the shell and connected to the shell by a film-type hinge enabling pivoting thereof between an extended position outside the shell for forming the entire integral bracket, and a reinforcing position in which the same is stowed inside the housing for stiffening the shell.

The present invention relates to a console suitable for being attached to the chassis of a motor vehicle.

Such a console (usually made of plastic) is known of the type comprising a shell which defines an enclosure, and a reinforcement attached to the shell, in the enclosure, and designed to reinforce the rigidity of the shell. The reinforcement, produced independently of the shell, is attached to the latter, usually by welding. Such a console is relatively costly since it requires the manufacture of two independent parts (the shell and the reinforcement), or even more (if there are several reinforcements), and the assembly of all these parts. The costs are associated with the existence of the various steps necessary to manufacture the console and to manage these steps and the parts.

The object of the present invention is to remedy the aforementioned drawbacks.

According to the invention, in the console of the aforementioned type, the reinforcement comprises at least one reinforcing element which is made of the same material and in one piece with the shell and is connected to the latter by a film hinge allowing it to pivot between a deployed position outside the shell in order to produce the integrality of the one-piece console, and a reinforcing position in which it is retracted inside the enclosure to stiffen the shell.

Therefore, according to the invention, the console is made in a single step, for example by molding, each reinforcing element being linked to the shell from the start. Since the connection between a reinforcing element and the shell is formed by a film hinge, that is to say by a zone of weakening of material, it is possible to produce the console by molding, each reinforcing element being molded in a position outside the enclosure in order to allow the console to be removed from the mold, and then each reinforcing element can pivot so that they occupy their reinforcing position in the enclosure.

Other particular features and advantages of the present invention will appear in the description of an embodiment given as a nonlimiting example and illustrated by the appended drawings in which:

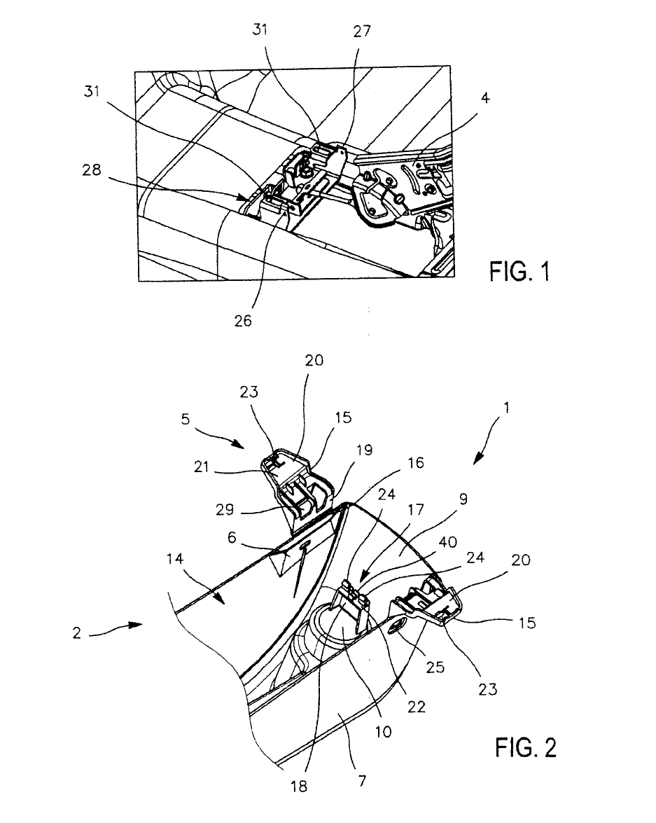

FIG. 1 is a view in perspective of the location intended to be covered by a console according to the present invention;

FIG. 2 is a view in perspective from below of a console according to the present invention, the reinforcing elements being in the deployed position;

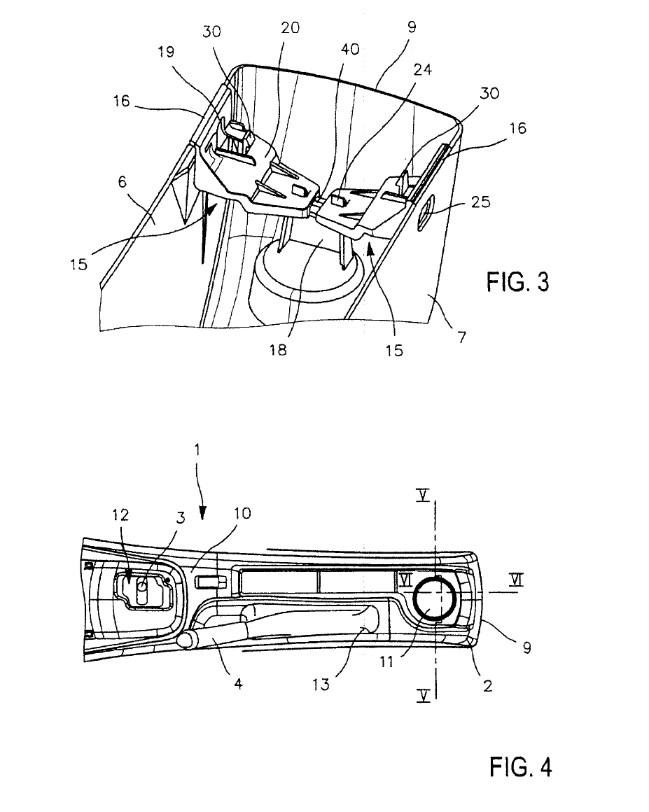

FIG. 3 is a view similar to FIG. 2, the reinforcing elements being in the reinforcing position;

FIG. 4 is a top view of the console placed in the location that was intended for it;

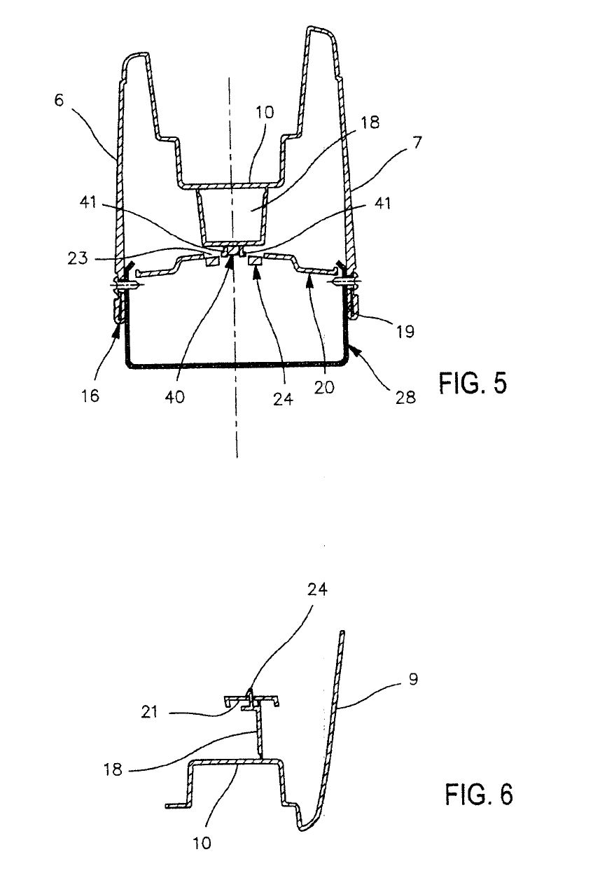

FIG. 5 is a view in cross section along the straight line V-V of FIG. 4, and

FIG. 6 is a view in longitudinal section along the straight line VI-VI of FIG. 4.

FIG. 2 represent a console 1 suitable for being attached to the chassis of a motor vehicle. In this instance, it is a console 1 suitable for being attached between the seat of the driver and that of the front passenger.

The console 1 comprises, on the one hand, a shell 2 defining an enclosure which, in the present example, is suitable for enveloping the mechanisms of a gearchange control 3 and those of a handbrake 4, and, on the other hand, a reinforcement 5 attached to the shell 2, in the enclosure, and designed to reinforce the rigidity of the shell 2.

In the present embodiment, the shell 2 comprises a driver said wall 6 suitable for being placed alongside the seat of the driver, a passenger side wall 7 suitable for being placed alongside the front passenger seat, a front side wall 8 suitable for being placed next to the instrument panel of the vehicle, a rear side wall 9 and a top wall 10 which comprises a storage tray 11, a first passageway aperture 12 to allow the handbrake lever 4 to pass through, and a second passageway aperture 13 to allow the gearchange lever lever 3 to pass through. The four side walls 6, 7, 8, 9 and the top wall 10 delimit the enclosure. The shell 2 also comprises a lower aperture 14 which is delimited by the lower edges of the four side walls 6, 7, 8, 9 and which is suitable for resting on the chassis.

The reinforcement 5 comprises at least one reinforcing element 15 (in this instance, two reinforcing elements 15), each reinforcing element 15 being made of the same material and in one piece with the shell 2 and connected to the latter by a film hinge 16. In this instance, the two reinforcing elements 15 are supported by two side walls facing one another (in this instance, the driver side wall 6 and passenger side wall 7), and, themselves, face one another.

The film hinge 16, formed by a zone of weakening of material, allows the corresponding reinforcing element to pivot between a deployed position outside the shell 2 (see FIG. 2) which makes it possible to achieve the integrality of the one-piece console 1 (particularly by molding when the console is made of plastic), and a reinforcing position (see FIGS. 3, 5 and 6) in which the reinforcing element 6 is retracted inside the enclosure and placed so as to stiffen the shell 2. More precisely, each film hinge 16 connects the corresponding reinforcing element 15 to the lower edge of the corresponding side wall 6, 7.

In the present embodiment, in order to improve the rigidity of the console 1 when the reinforcing elements are in their reinforcing position, the shell 2 comprises an immobilization structure 17 at which the reinforcing elements 15 are immobilized (and to which, even, in this instance, they are attached). This immobilization structure 17, in this instance, comprises an inner wall 18 supported by the inner surface of one of the walls 6, 7, 8, 9, 10 delimiting the enclosure (in this instance, the top wall 10). This inner wall 18 is made of the same material and in one piece with the shell 2. Still for the purpose of improving the rigidity, when the reinforcing elements 15 are in their reinforcing position, they are partly placed against the inner surface of the side wall 6, 7 to which they are attached by the film hinge 16. Therefore, each reinforcing element 15 provides a mechanical link between a side wall 6, 7 delimiting the shell and another wall at a distance from this first wall 6, 7 (in this instance, an inner wall 18 supported by the top wall 10 and being substantially halfway between the two side walls 6, 7 supporting the two reinforcing elements 15).

More precisely, each reinforcing element 15 has the shape of an angle bracket and it has, on the one hand, a connecting lug 19 which extends from the film hinge 16, and, on the other hand, a fastening lug 20 which extends from the free end of the connecting lug 19. In the present embodiment, the two lugs 19, 20 are perpendicular to one another.

Therefore, when a reinforcing element 15 is in its reinforcing position, the connecting lug 19 extends along the inner surface of the side wall 6, 7 to which it is connected by the film hinge 17. Similarly, when a reinforcing element 15 is in its reinforcing position, the fastening lug 20 butts against the free end of the immobilization structure 17. In this instance, the fastening lug 20 comprises a stop surface 21 which butts against an abutment surface 22 situated at the free end of the inner wall 18. In order to improve the rigidity of the console 1, when a reinforcing element 15 is in its reinforcing position, the fastening lug 20 is attached (that is to say locked) to the immobilization structure 17. In this instance, the fastening lug 20 comprises a fastening member 23 which is suitable for interacting with a matching fastening member 24 situated at the free end of the inner wall 18. Precisely, the matching fastening member 24 is formed by an elastically deformable tongue 24 protruding from the abutment surface 22 which is suitable for snap-fitting into a fastening aperture 23 forming the fastening member 23, the tongue 24 comprising a hook-shaped free end suitable for passing through the corresponding aperture.

Finally, in order to prevent a movement of the reinforcing elements 15 due to the length of the fastening lugs 20, which is slightly less than half the width of the shell 2, the immobilization structure 17 comprises, at its free end, a wedging rib 40 against which the free end 41 of the fastening lugs 20 come into contact with friction.

Therefore, in the present embodiment, it is easy to produce a particularly rigid console 1: after the one-peice piece assembly formed by the shell 2 (including the inner wall 18) and the reinforcing elements 15 are removed from the mold, the latter are pivoted until they butt against the inner wall 18 and until they snap-fit into it.

Moreover, in order to allow the fastening of the console 1 to the chassis (in this instance, between the two front seats), the two side walls, the driver side wall 6 and passenger side wall 7, comprise an opening allowing a screw to pass through which also traverses a matching opening 26 made on the chassis (in this instance, made on a lug 27 of a stop plate 28 for the handbrake cable sheath). Moreover, in order to improve the rigidity, the screw allowing the connection of the console 1 to the chassis also traverses an additional opening 29 which is supported by the corresponding connecting lug 19 and which is in line with the opening 25 and the matching opening 26 when the reinforcing element 15 is in its reinforcing position.

Finally, in order to make it easier to attach the console 1 to the chassis, each fastening lug 20 comprises a fastening element 30 which, when the reinforcing element 15 is in its reinforcing position, it suitable for interacting with a matching fastening element 31 supported by the chassis. In this instance, the fastening element 30 is formed by an elastically deformable tongue 30 protruding from the fastening lug which is suitable of for snap-fitting into a fastening orifice 31 forming the matching fastening element 31, the tongue 30 comprising a hook-shaped free end suitable for passing through the corresponding orifice which is made in the stop plate 28.

Therefore, in the present embodiment, it is easy to install the stiffened console 1: after immobilization of the reinforcing elements 15 in their reinforcing position, the console 1 is conveniently placed relative to the chassis, snap-fitted into the latter (by means of the fastening elements 29), then screwed (via the openings 24 and the additional openings 28).

The present invention is not limited to the present embodiment. It applies notably to any type of console usually installed in a passenger compartment of a motor vehicle, and not only the central console. The number of reinforcing elements may vary. The reinforcing elements could also comprise no fastening element allowing the console to be fastened to the chassis; they could equally have a different structure (other than that of two lugs perpendicular to one another), and in particular a single lug.

1.-10. (canceled)

11. A console configured to be attached to a chassis of a motor vehicle, comprising:
a shell that defines an enclosure; and
a reinforcement attached to the shell, in the enclosure, and configured to reinforce rigidity of the shell,
wherein the reinforcement comprises at least one reinforcing element made of a same material and in one piece with the shell and connected to the shell by a film hinge allowing the reinforcement to pivot between a deployed position outside the shell to produce integrality of the one-piece console, and a reinforcing position in which the reinforcement is retracted inside the enclosure to stiffen the shell.

12. The console as claimed in claim 11, wherein each reinforcing element has a shape of an angle bracket that includes a connecting lug extending from the film hinge, and a fastening lug extending from a free end of the connecting lug.

13. The console as claimed in claim 12, wherein the connecting lug of each reinforcing element is connected by the corresponding film hinge to a lower edge of a side wall of the shell delimiting the enclosure.

14. The console as claimed in claim 13, wherein the connecting lug of each reinforcing element extends along the side wall, to which it is connected by the film hinge, when the reinforcing element is in its reinforcing position.

15. The console as claimed in claim 12, wherein the fastening lug of each reinforcing element comprises a stop surface which butts against an inner wall, which inner wall is supported by an inner surface of a wall delimiting the enclosure, when the reinforcing element is in its reinforcing position.

16. The console as claimed in claim 12, wherein the fastening lug of each reinforcing element comprises a fastening member that interacts with a matching fastening member, which fastening member is supported by an inner wall supported by an inner surface of a wall delimiting the enclosure, when the reinforcing element is in its reinforcing position.

17. The console as claimed in claim 16, wherein the fastening member includes a fastening aperture configured to receive by snap-fitting an elastically deformable tongue forming the matching fastening member.

18. The console as claimed in claim 12, wherein the fastening lug of each reinforcing element comprises a fastening element or an elastically deformable tongue, configured to interact or to snap-fit, with a matching fastening element or an aperture, which matching fastening element is supported by the chassis, when the reinforcing element is in its reinforcing position.

19. The console as claimed in claim 11, configured to be attached to the chassis between a seat of a driver and that of a front passenger, the shell comprising a driver side wall, a passenger side wall, a front side wall, a rear side wall, and a top wall that delimit the enclosure suitable for enveloping mechanisms of a gearchange control and those of a handbrake, and a lower aperture delimited by the lower edges of the four side walls.

20. The console as claimed in claim 11, comprising two reinforcing elements supported by two side walls facing one another.
